(19) United States
(12) Patent Application Publication
(10) Pub. No.: US 2022/0126132 A1
(43) Pub. Date: Apr. 28, 2022

(54) TIGHT FITTING RESPIRATOR WITH EXHALATION FILTER AND EXHALATION FILTER FOR TIGHT FITTING RESPIRATOR

(71) Applicant: CLEANSPACE IP PTY LTD, St. Leonards, New South Wales (AU)

(72) Inventors: Jonah BEARD, Palm Beach (AU); Alexander VIRR, Mangrove Mountain (AU); John SNOW, Killarney Heights (AU); Damian JOHNSON, Forestville (AU); Alexandra BIRRELL, Greenwich (AU)

(73) Assignee: CLEANSPACE IP PTY LTD, St. Leonards, New South Wales (AU)

(21) Appl. No.: 17/428,048

(22) PCT Filed: Feb. 5, 2020
(86) PCT No.: PCT/AU2020/050082

§ 371 Date: Aug. 3, 2021

Related U.S. Application Data
(60) Provisional application No. 62/802,106, filed on Feb. 6, 2019.

(51) Int. Cl. A62B 23/02; A62B 18/10; A62B 18/08; A41D 13/11; B01D 46/16; B01D 46/52; B01D 46/62; B01D 46/00; B01D 46/42

(52) U.S. Cl. CPC A62B 23/025; A62B 18/10; A62B 18/084; A41D 13/11; B01D 46/16; B01D 46/521; B01D 2273/30; B01D 46/0043; B01D 46/4272; B01D 46/0005; B01D 2265/024; B01D 2265/06; B01D 46/62

(57) ABSTRACT

A powered air purifying respirator includes an inlet air filter; a flow generator configured to cause air from an ambient environment to flow through the inlet air filter and elevate pressure of the air to above ambient conditions; a mask in fluid communication with the flow generator and configured to fit tightly against a user's face or neck for delivery of the air to the user at the elevated pressure; and a one-way outlet valve configured to allow air exhaled by the user to be vented to the ambient environment. An outlet filter may be included to filter the air flowing through the one-way valve, and the outlet filter may be retrofit. The outlet filter may be preferred when filtration of both inlet and outlet air is desirable.

### PRIORITY APPLICATION

The present application claims priority from U.S. basic application 62/802,106, filed on 6 Feb. 2019, the entirety of which is hereby incorporated by reference.

### BACKGROUND

For the general public, protection from pollution and disease in their daily life relies largely on dust or surgical marks. However, these masks only provide basic protection, due to leakage around the masks, even when the filter material used in making such masks is typically labeled as suitable for high efficiency filtering. Due to the extra resistance imposed by the filter media, the user has to breathe considerably harder than they normally do without the mask. Thus, it is quite difficult for anyone to use such a mask comfortably for a prolonged period. Furthermore, CO₂ and moisture accumulate inside the mask, which tends to make the situation worse. In addition, the higher the efficiency of the filter media, the higher the flow resistance it will impose, thus making these masks even more uncomfortable for prolonged use. Such effects are particularly obvious for those who have weak or impaired respiratory systems, such as elderly people, children, and the sick, such as asthma and COPD patients.

Dust and surgical masks have been widely used by the general public largely because of their ease of use. Powered air purifying respirator (PAPR) solutions are available should anyone wish to use a more efficient and comfortable device. A tight-fitting PAPR is one in which the mask is designed to seal to the face or neck of the user. Tight-fitting PAPRs must be provided with a means of releasing exhaled air. Typically, this takes the form of at least one one-way valve (“exhalation valve”) positioned at or near the front of the mask. Thus when the user exhales, air from their lungs is discharged into the environment in the immediate vicinity of their face.

U.S. Patent Application Publication No. 2012/0174922 to Virr et al., and U.S. Patent Application Publication No. 2014/0373846 to Kao et al., which are hereby incorporated by reference in their entireties, disclose PAPR solutions. These PAPR solutions provide filtered air to the mouth and/or nose of the user at pressure over ambient conditions and allow venting of exhaled air to atmosphere through a valve.

### BRIEF SUMMARY

The devices described in U.S. Patent Application Publication No. 2012/0174922 and U.S. Patent Application Publication No. 2014/0373846 included significant advances in the art. However, further advancements are desirable. For example, it may be desirable to filter air exhausted from the PAPR to reduce the likelihood that the user of the PAPR will contaminate the environment.

In a first example, a powered air purifying respirator includes an inlet air filter; a flow generator configured to cause air from an ambient environment to flow through the inlet air filter and elevate pressure of the air to above ambient conditions; a mask in fluid communication with the flow generator and configured to fit tightly against a user's face or neck for delivery of the air to the user at the elevated pressure; a one-way outlet valve configured to allow air exhaled by the user to be vented to the ambient environment; and an outlet filter configured to filter the air flowing through the one-way valve.

Further aspects of the first example may include that (a) the outlet filter is removably attached to the mask; (b) the outlet filter comprises a retention member located to be between a portion of the mask and the user's face when the respirator is worn; (c) the retention member is a strap; (d) the powered air purifying respirator comprises a flow conduit fluidly connecting the flow generator and the mask, and the flow conduit passes through a portion of the outlet filter; (e) the flow conduit is part of the mask; (f) the outlet filter comprises a filter media and a frame that retains the filter media; (g) the frame comprises a retention member located to be between a portion of the mask and the user's face when the respirator is worn; (h) the frame is flexible; and/or (i) the frame comprises a flexible plastic.

In a second example, an outlet filter for use with a powered air purifying respirator that includes a mask with an air outlet comprises a filtration media; a flexible frame supporting the filtration media, the flexible frame including a first member attached to the filtration media at a perimeter of the filtration media, and a second member configured to attach the outlet filter to the mask.

Further aspects of the second example may include that (a) the flexible frame further comprises a third member supporting a central portion of the filtration media; (b) the third member extends across a height or width of the filtration media and connects to the first member at opposite ends of the third member; (c) the third member is attached to the filtration media to prevent the filtration media from pressing against the air outlet; (d) the flexible frame comprises a plurality of the third member; (e) the second member bounds an opening sized to allow a portion of the mask to pass through the opening to retain the outlet filter to the mask; (f) the portion of the mask is an air delivery conduit; and/or (g) the flexible frame comprises plastic.

In a third example, a method of retrofitting a powered air purifying respirator comprises selecting a filter to cover an air outlet of the powered air purifying respirator; and attaching the filter to a mask of the powered air purifying respirator. The mask may include arms with flow conduits, and the filter may straps such that the straps are wrapped around the arms to attach the filter to the mask

Other aspects, features, and advantages of this technology will become apparent from the following detailed description when taken in conjunction with the accompanying drawings, which are a part of this disclosure and which illustrate, by way of example, principles of this technology.

### BRIEF DESCRIPTION OF THE DRAWINGS

FIG. 1 illustrates a perspective view of a mask for a PAPR with an outlet filter attached.

FIG. 2 illustrates the side view of a PAPR with an outlet filter attached.

FIG. 3 illustrates a perspective view of a PAPR without an outlet filter attached.

FIG. 4 illustrates a perspective view of a mask for a PAPR with an outlet filter attached.

FIG. 5 illustrates a perspective view of a mask for a PAPR with two outlet filters attached.

FIG. 6 illustrates a perspective view of a mask for a PAPR with an outlet filter attached.

FIG. 7 illustrates a perspective view of a mask for a PAPR with two outlet filters attached.

### DETAILED DESCRIPTION

According to the National Institute of Occupational Safety and Health (NIOSH), PAPR “use in the Operating Room (OR) has not been recommended as there is a lack of scientific evidence to support safe usage of this type of device and the possible impact (contamination of wearer's exhaled, unfiltered air) onto the sterile field.”

[https://www.cdc.gov/niosh/npptl/topics/respirators/disp_part/respsource3healthcare.html]

In some applications where tight-fitting PAPRs may be useful there is a need to ensure that bacteria, viruses, DNA material or other foreign particles (contaminants) that may be present in the user's exhaled air do not reach the environment outside the mask. For instance, in acute care it is vital that any infectious agents aerosolized from the healthcare workers mouth, nose or lungs do not contaminate the sterile field or put immunocompromised patients at risk, where the infectious agents might cause a life threatening complications or infection. Other examples include i) pharmaceutical production or development operations where it is necessary to maintain a sterile environment to prevent contamination of therapeutics (either of the active ingredients, media, cell lines (biologicals) or sterile vials) and ii) research laboratories to prevent technicians/researchers from contaminating cell cultures or genetically modified laboratory animals (e.g., transgenic animals) with foreign viruses, bacteria or DNA that destroy valuable experiments or cell/animal lines. These exemplary uses of a PAPR may be generally described as use in an environment where the user desires air to be filtered prior to inhalation and it is necessary or desirable for the wearer's exhaled air to be filtered before being returned to the ambient environment.

Standard practice within operating theatres is to wear a surgical mask. A surgical mask looks superficially like an N95 mask (with no exhalation valve) but is not a particulate respirator and only provides barrier protection against droplets including large respiratory particles.

[https://www.cdc.gov/niosh/npptl/topics/respirators/disp_part/respsource3healthcare.html] Some N95 masks (without exhalation valves) are also suitable for use in the operating theatre and are recommended by CDC in preference to surgical masks. Such masks provide greater than 95% filtration of particles 0.3 microns and above at a flow rate of 85 liters/minute.

Surgical Masks and N95 masks both suffer from a rapid build-up of heat and moisture within the mask. Users find them tiring to wear for long periods due to the added work of breathing resulting from the flow resistance of the filter. While they provide a good level of overall protection when perfectly fitted, they are vulnerable to leakage between the mask and the user's face when poorly fitted, badly adjusted or when the user becomes hot, tired or forgets to check and adjust their seal. Permitted CO₂ levels inside these masks are also far higher (double) those permitted in powered respirators, which is likely to induce discomfort and fatigue.

Some surgeons use a helmet-mounted fan inside their hood or surgical gown to provide air circulation and cooling. An example of this type of device is the T5 Personal Protection System sold by Stryker. The T5 circulates air within the hood and gown, reducing the surgeon's body temperature and probably reducing the build-up of CO₂ in the hood. It does not filter the incoming air, nor does it filter the exhaled air. Instead it relies on the air being discharged from the hood and gown a (relatively) long way from the sterile field. Studies suggest that this system is effective at reducing the concentration of airborne particles at the sterile site.

A tight fitting PAPR may provide advantages over surgical masks and N95 masks, such as reduced buildup of heat and/or CO₂, in these environments if the PAPR can provide adequate filtration of exhaled air. At this time, there are no readily available international or other standards that govern the filtration efficiency of exhalation filters for a PAPR. Surgical masks are not regulated by NIOSH or others and have low and widely varying levels of filtration efficiency. N95 respirators are required to have greater than 95% filtration of particles 0.3 microns and larger at 85 liters/minute flow. The same level of protection as N95 respirators may provide a reasonable performance goal for exhalation filters on PAPRs.

Including an exhalation filter with a PAPR should still meet all requirements of the relevant PAPR standards. A relevant standard in the United States is 42 CFR Part 84, which requires that the pressure in the mask not rise above 20 mm H₂O with an exhalation flow rate of 85 liter/min. To meet this requirement, the exhalation filter must have sufficiently low flow resistance when fitted to the PAPR. With current filtration media, simple caps that fit snuggly over the exhalation valve may have difficulty meeting this need.

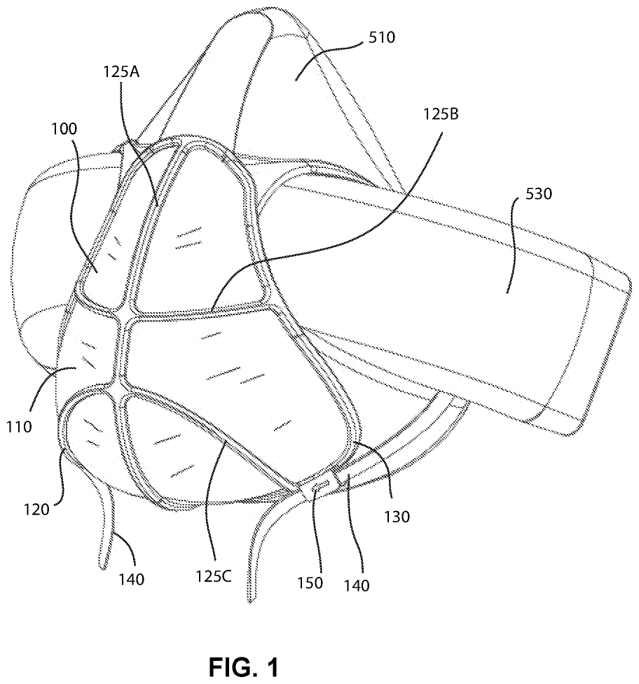

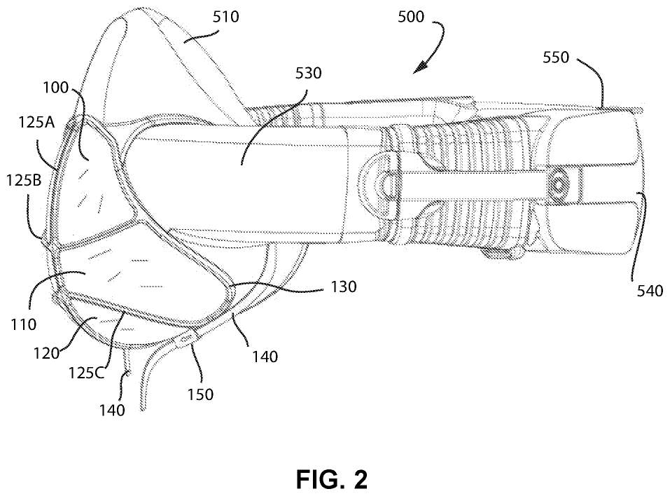

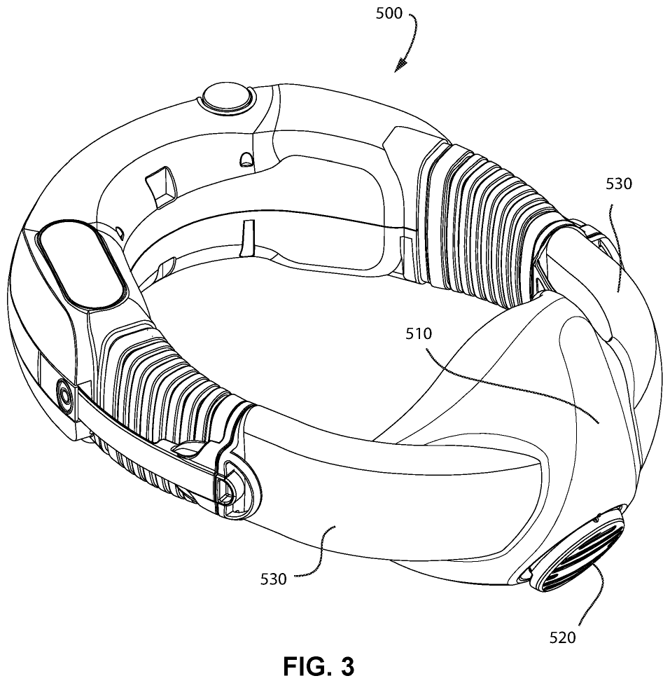

FIG. 1 illustrates a filter 100 that may be installed on a PAPR 500 (see FIG. 2) to provide filtration of exhaled air. Advantageously, the configuration of FIG. 1 may be retrofit to a preexisting PAPR 500 that did not originally include an exhalation filter. In FIG. 1, the mask 510 is illustrated detached from the rest of the PAPR 500. The exhalation valve 520 (illustrated in FIG. 3) is covered by the filter 100 and not visible in FIG. 1 or 2. In order to achieve a target exhalation resistance (e.g., 20 mm H₂O with an exhalation flow rate of 85 liter/min), the area of the filtration media 110 may need to be larger than the area of the exhalation valve 520, particularly if the filter 100 is retrofit to a preexisting PAPR 500. The exact area of filtration media 110 required will vary from one PAPR design to the next and with the type of media used. In one example, for a small breath-responsive PAPR (i.e., a PAPR that generates or increases flow in response to inhalation by the user) using electrostatic media an area of 50-60 cm² may be appropriate. Of course a greater area may be used and may reduce flow resistance, but too much filtration media could have undesirable effects such as obscuring the view of the user.

Other components of a PAPR 500 may include an inlet filter (an interior component generally at 540) and a flow generator (an interior component generally at 550).

The filter 100 may be formed using a relatively large area (compared, for example, to the size of the exhalation valve 520) of filtration media 110 where the filter 100 is in the form a secondary mask which fits over the mask 510 of the PAPR 500. The filter 100 may include a frame 120 to which the filtration media 110 is attached. The frame 120 may be made from flexible material such as polyethylene, polypropylene or ABS. The filtration media 110 may be attached to the frame 120 using any suitable method, two examples being heat welding and adhesive.

The frame 120 may include an outer peripheral member 130 at or near the edge of the filtration media 110. The outer peripheral member 130 may function to hold the edges of the filtration media 110 in contact with (or close to) the exterior surface of the mask 510 around the entire periphery of the filtration media 110. Holding the filtration media in contact with (or close to) the exterior surface of the mask 510 tends to prevent particles from leaking around the outer edges of the filtration media 110, which should improve filtration efficiency. Of course, the filtration media 110 could also extend beyond the outer peripheral member 130 but this may not be an efficient use of the filtration media 110 because any filtration media 110 extending outward of the outer peripheral member 130 may not provide significant filtration benefit.

The frame 120 may include members spanning between opposed sides of the peripheral member 130. Any number of members can be provided. Three such frame members 125A, 125B and 125C are illustrated. In FIG. 1, member 125A extends vertically (e.g., across the height of the filtration media 110) so that opposed ends intersect with the peripheral member 130 and intersects at a central portion with members 125B and 125C, both of which extend laterally (e.g., across a width of the filtration media 110) so that opposed ends intersect with the peripheral member 130. The intersections may include fillets (as illustrated), which are often included to eliminate stress concentration that would occur at sharp corners. Here the fillets also increase the surface area of the intersections, which have an added benefit of providing more surface area for attachment of the frame 120 to the filtration media 110. When viewed towards the front of the PAPR 500, the frame members 125A and 125B are substantially straight whereas the frame member 125C is an inverted U-shape. Other shapes may be used for any of the frame members 125A, 125B and 125C.

The frame 120 is illustrated on the outside surface of the filtration media 110. The frame 120 could be interior to the filtration media 110. However, including the frame on the outside surface of the filtration media 110 will tend to press the filtration media 110 against the mask 510. The filtration media 110 may be more likely to conform to the surface of the mask 510 than the frame 120, which should increase the likelihood of any particle flowing into the filtration media 110 and thus being filtered out of the air.

The filter 100 is preferably retained to the mask 510 in a manner that allows for removal and replacement without replacement of the mask 510, although removal of the mask 510 from the PAPR 500 may be part of a process for replacing the filter 100. As illustrated in FIG. 1, the filter 100 includes members, illustrated in the form of straps 140, that retain the filter 100 to the mask 510. As illustrated, the straps 140 pass around arms 530 of the mask 510 to be located between a portion of the mask 510 and a user's face when the PAPR 500 is worn, but in other configurations the straps 140 may pass around any suitable structure of the PAPR 500 to retain the filter 100 to the PAPR 500. The straps 140 may be relatively thinner protrusions from the frame 120, separate elastic or string structures or a combination of the two. The straps 140 may made from the filtration media 110, although this may not be as robust as other configurations.

The filter 100 may include cleats 150 (an exemplary strap locking mechanism) to retain the straps 140. The cleats 150 are preferably configured such that the straps 140 are readily inserted but removal is resisted. In one form, the cleats 150 may be single use similar to the locking mechanism on plastic cable ties. Other strap locking mechanisms may include hook and loop fastener, snaps or buttons. If cleats 150 are used, the cleats 150 are preferably located such that a free end of each of the straps 140 may pass around the arms 530 (or other suitable structure of the mask 510) and through a respective one of the cleats 150 to adjust the straps 140. By adjusting the strap tension, contact between the lower edge of the filter 100 and the lower surfaces of the mask 510 can be controlled and/or adjusted. The cleats 150 may be omitted if, for example, adjustment is not necessary.

The frame 120 preferably combines sufficient stiffness to hold the filtration media 110 away from the exhalation valve 520 (to reduce flow resistance) while being flexible enough to provide a good fit on a variety of mask sizes (and the variation in mask shape that occurs when the masks are fitted to users with differently-shaped faces). The members 125A, 125B and 125C and/or the outer peripheral member 130 may be designed (e.g., material selection and/or geometry) to provide the desired balance of stiffness and flexibility. The frame 120 and its members may be made from any suitable material such as plastic. Suitably flexible plastic may include polyethylene, polypropylene or ABS. The frame 120 may be fabricated with known molding techniques. The filtration media 110 may be attached to the frame 120 by any suitable method, which includes at least heat welding and/or gluing.

An exemplary material for the filtration media 110 is a needle-punched non-woven fabric, which uses an electrostatic mechanism to provide high levels of filtration. One such media is Tribo 400NGH, made by Texel Technical Materials, Inc.

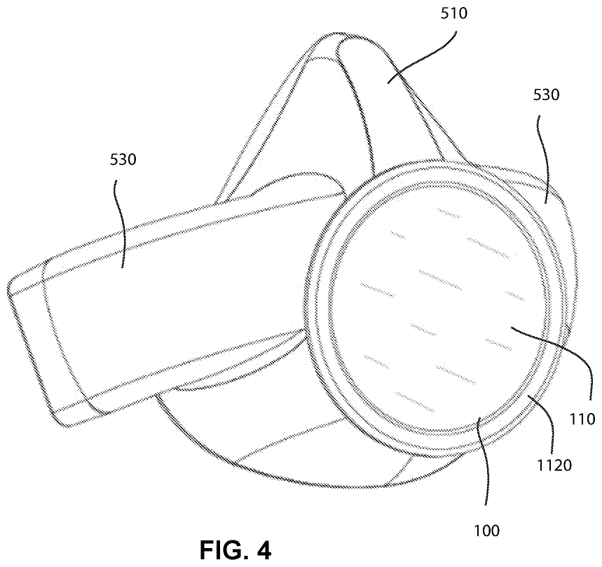

FIG. 4 illustrates another configuration of the filter 100 where the filtration media 110 is fitted to a frame 1120 which fits directly around the exhalation valve 520 (not visible in FIG. 4) and seals either to the body of the exhalation valve 520 or to the surrounding surfaces of the mask 510. The materials and construction details are similar to the configuration illustrated in FIG. 1, but there are no straps or cleats. The frame 1120 may be attached to the exhalation valve 520 with a friction fit if used with a preexisting mask 510 (e.g., a retrofit) or attached by other suitable connection (e.g., a threaded connection or snap connection) if the mask 510 is designed to accept the other suitable connection. Suitably low pressure drop may be achieved by the frame 1120 providing a greater area for the filtration media 110 than the area of the exhalation valve 520. The frame 1120 may include a relatively small aperture that connects to the exhalation valve 520 and include a relatively large aperture that provides sufficient area for the filtration media 110 (e.g., to achieve a desirable pressure drop).

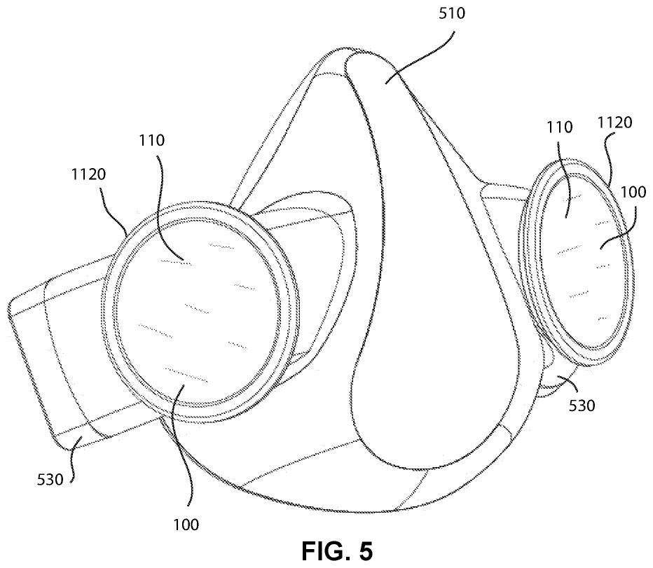

FIG. 5 illustrates another configuration in which it may be possible to achieve lower exhalation resistance by providing the mask 510 with two exhalation valves (not visible), each then provided with its own filter 100. The construction of the filter 100 could be substantially the same as that illustrated in FIG. 4, but may be a smaller size (e.g., diameter) than the configuration of FIG. 4. This configuration may be advantageous because it moves both the valve 520 and the filter 100 from the front of the mask, making the wearer's mouth more visible, which contributes to ease of communication and a less threatening look. However, preexisting masks 510, where the valve 520 is centrally located, may need to be replaced.

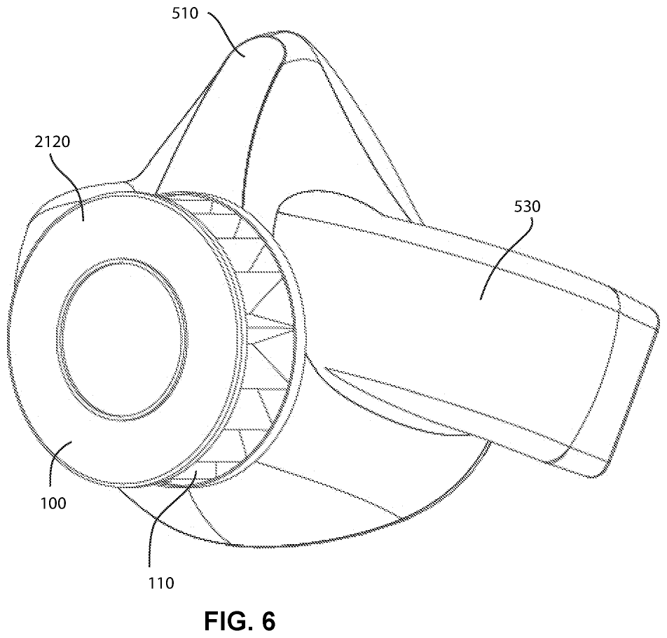

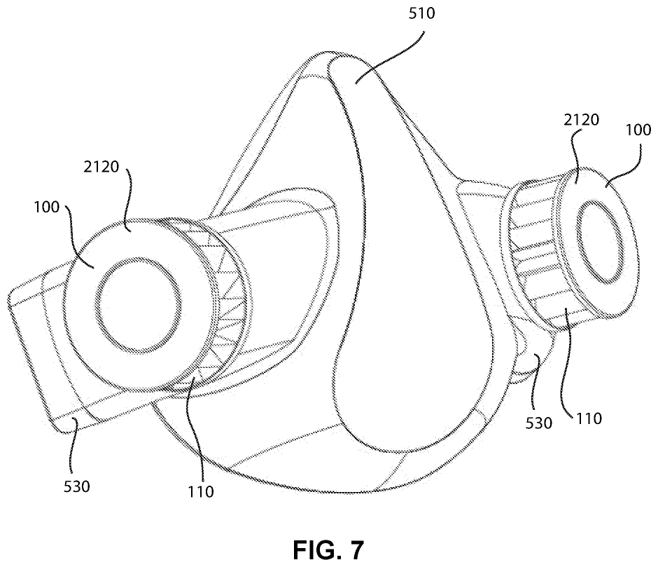

Use of alternate media is also possible. FIGS. 6 and 7 are similar to FIGS. 4 and 5, respectively, in the relative positions of the filter 100. These configurations differ primarily in that the filtration media 110 is pleated media made from micro-fine glass fibers. For example 4450-HS media made by Lydall, Inc. may be suitable. Use of a synthetic media (in which the fibers are made from polymer rather than glass) is also possible. The frame 2120 also differs as necessitated by configuration of the pleated media.

While the present technology has been described in connection with several practical examples, it is to be understood that the technology is not to be limited to the disclosed examples, but on the contrary, is intended to cover various modifications and equivalent arrangements included within the spirit and scope of the technology.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

1. A powered air purifying respirator comprising
an inlet air filter;
a flow generator configured to cause air from an ambient environment to flow through the inlet air filter and elevate pressure of the air to above ambient conditions;
a mask in fluid communication with the flow generator and configured to fit tightly against a user's face or neck for delivery of the air to the user at the elevated pressure;
a one-way outlet valve configured to allow air exhaled by the user to be vented to the ambient environment; and
an outlet filter configured to filter the air flowing through the one-way valve.

2. The powered air purifying respirator according to claim 1, wherein the outlet filter is attached to the mask.

3. The powered air purifying respirator according to claim 1, wherein the outlet filter is removably attached to the mask.

4. The powered air purifying respirator according to claim 1, wherein the outlet filter comprises a retention member located to be between a portion of the mask and the user's face when the respirator is worn.

5. The powered air purifying respirator according to claim 4, wherein the retention member is a strap.

6. The powered air purifying respirator according to claim 1, further comprising a flow conduit fluidly connecting the flow generator and the mask, wherein the flow conduit passes through a portion of the outlet filter.

7. The powered air purifying respirator according to claim 6, wherein the flow conduit is part of the mask.

8. The powered air purifying respirator according to claim 1, wherein the outlet filter comprises a filter media and a frame that retains the filter media.

9. The powered air purifying respirator according to claim 8, wherein the frame comprises a retention member located to be between a portion of the mask and the user's face when the respirator is worn.

10. The powered air purifying respirator according to claim 8, wherein the frame is flexible.

11. The powered air purifying respirator according to claim 8, wherein the frame comprises a flexible plastic.

12. An outlet filter for use with a powered air purifying respirator that includes a mask with an air outlet, the outlet filter comprising
a filtration media; and
a flexible frame supporting the filtration media, the flexible frame including a first member attached to the filtration media at a perimeter of the filtration media, and a second member configured to attach the outlet filter to the mask.

13. The outlet filter according to claim 12, wherein the flexible frame further comprises a third member supporting a central portion of the filtration media.

14. The outlet filter according to claim 13, wherein the third member extends across a height or width of the filtration media and connects to the first member at opposite ends of the third member.

15. The outlet filter according to claim 13, wherein the third member is attached to the filtration media to prevent the filtration media from pressing against the air outlet.

16. The outlet filter according to claim 13, wherein the flexible frame comprises a plurality of the third member.

17. The outlet filter according to claim 12, wherein the second member bounds an opening sized to allow a portion of the mask to pass through the opening to retain the outlet filter to the mask.

18. The outlet filter according to claim 17, wherein the portion of the mask is an air delivery conduit.

19. The outlet filter according to claim 12, wherein the flexible frame comprises plastic.

20. A method of retrofitting a powered air purifying respirator, the method comprising
selecting a filter to cover an air outlet of the powered air purifying respirator; and
attaching the filter to a mask of the powered air purifying respirator.

21. The method of claim 20, wherein the mask comprises arms with flow conduits, and the filter comprises straps, the method further comprising wrapping the straps around the arms to attach the filter to the mask.
